(19) United States
(12) Patent Application Publication
(10) Pub. No.: US 2011/0060583 A1
(43) Pub. Date: Mar. 10, 2011

(54) AUTOMATIC TRANSLATION SYSTEM BASED ON STRUCTURED TRANSLATION MEMORY AND AUTOMATIC TRANSLATION METHOD USING THE SAME

(75) Inventors: Sung Kwon CHOI, Daejeon (KR); Ki Young Lee, Daejeon (KR); Yoon Hyung Roh, Daejeon (KR); Oh Woog Kwon, Daejeon (KR); Chang Hyun Kim, Daejeon (KR); Young Ae Seo, Daejeon (KR); Seong II Yang, Daejeon (KR); Yun Jin, Daejeon (KR); Jinxia Huang, Daejeon (KR); Yingshun Wu, Daejeon (KR); Changhao Yin, Daejeon (KR); Eun Jin Park, Daejeon (KR); Young Kil Kim, Daejeon (KR); Sang Kyu Park, Daejeon (KR)

(73) Assignee: Electronics and Telecommunications Research Institute, Daejeon (KR)

(21) Appl. No.: 12/646,947

(22) Filed: Dec. 23, 2009

(30) Foreign Application Priority Data
Sep. 10, 2009 (KR) 10-2009-0085422

(51) Int. Cl. G06F 17/28

(52) U.S. Cl. 704/2; 704/E21.001

(57) ABSTRACT

Provided are an automatic translation system based on structured translation memory and an automatic translation method using the same. In the automatic translation system, a translation memory establishment module changes a predetermined language pattern into a part translation pattern and registers the changed part translation pattern in a structured translation memory. A sentence unit translation module performs a translation of the sentence unit on an input sentence on the basis of the translation memory. A part combination translation module analyzes a structure of a language pattern less than the sentence unit which is included in the input sentence, searches the registered part translation pattern which is matched with the analyzed language pattern on the basis of the translation memory, and combines the searched part translation pattern to output a translation corresponding to the input sentence.

### CROSS-REFERENCE TO RELATED APPLICATIONS

This application claims priority under 35 U.S.C. §119 to Korean Patent Application No. 10-2009-0085422, filed on Sep. 10, 2009, in the Korean Intellectual Property Office, the disclosure of which is incorporated herein by reference in its entirety.

### TECHNICAL FIELD

The following disclosure relates to an automatic translation system and an automatic translation method using the same, and in particular, to an automatic translation system based on structured translation memory and an automatic translation method using the same.

### BACKGROUND

As a translation system, there are a Translation Memory (TM), a computer-aided translation tool (hereinafter referred to as a CAT) using the TM, an automatic translation system, and a system which connects the TM and the automatic translation system.

The CAT supports the translation of translators through the TM. The TM is a kind of database in which the original and a translation are configured with one pair. The TM stores a sentence, which has been translated by a translator before, in a database type. The CAT searches the TM and applies the search result to translation, when the translation request of an input sentence having the same expression as that of a preceding translation is received from a user. In the CAT, by reusing a preceding translation, the preceding translation or a repetitive sentence is not repeatedly translated. That is, the CAT provides the consistency and high efficiency of translation. On the other hand, because the TM stores preceding translated sentences in a character string, it has a low success rate for the search of the same sentence as an input sentence even when only one letter is wrongly translated. In the TM, that is, coverage is low.

The automatic translation system is one that automatically translates the input sentence of a first language into the translation of a second language, and provides a quick and consistent translation result by using translation dictionaries, translation rules, translation patterns and statistical translation information that exist inside it. On the other hand, the translation result of the automatic translation system is unnatural, and the total translation rate of the automatic translation system is low. This reason is because the translation rules, the translation patterns or the statistical translation information that are used in automatic translation have ambiguities in the meanings and styles of structures and vocabularies.

When a sentence identical to or similar to an input sentence is searched by the TM, the system that connects the TM with the automatic translation system uses a search result in translation. When not searched from the TM, the automatic translation system does not perform automatic translation. In the system that connects the TM and the automatic translation system, the automatic translation system supplements the low coverage of the TM, but the coverage of the TM is still low and the unnatural translation result of the automatic translation system is not still improved.

### SUMMARY

In one general aspect, an automatic translation system includes: a translation memory establishment module changing a predetermined language pattern into a part translation pattern by changing, deleting and substituting the predetermined language pattern less than a sentence unit, and registering the changed part translation pattern in a structured translation memory; a sentence unit translation module performing a translation of the sentence unit on an input sentence on the basis of the translation memory; and a part combination translation module analyzing a structure of a language pattern less than the sentence unit which is included in the input sentence, searching the registered part translation pattern which is matched with the analyzed language pattern on the basis of the translation memory, and combining the searched part translation pattern to output a translation corresponding to the input sentence, when the translation of the sentence unit is failed.

In another general aspect, an automatic translation method includes: changing a predetermined language pattern into a part translation pattern to establish a structured translation memory by changing, deleting and substituting the predetermined language pattern less than a sentence unit; performing a translation of the sentence unit on an input sentence on the basis of the translation memory; and analyzing a structure of a language pattern less than the sentence unit which is included in the input sentence, searching the translation memory, and combining the part translation pattern corresponding to the analyzed language pattern to output a translation, when the translation of the sentence unit is failed.

Other features and aspects will be apparent from the following detailed description, the drawings, and the claims.

### BRIEF DESCRIPTION OF THE DRAWINGS

FIG. 1 is a block diagram illustrating an automatic translation system based on structured translation memory according to an exemplary embodiment.

FIG. 2 is a flow chart illustrating an operation of establishing a translation memory database in FIG. 1.

FIG. 3 is a block diagram in which operations of establishing the structured translation memory of a first language sentence in FIG. 2 are implemented in module types.

FIG. 4 is a flow chart illustrating in detail an operation that establishes the structured translation memory of a second language sentence corresponding to the structured translation memory of the first language sentence in FIG. 2.

FIG. 5 is a flow chart illustrating an example of an operation which is performed in a sentence unit translation module in FIG. 1.

FIG. 6 is a flow chart illustrating an example of an operation which is performed in a sentence segment module in FIG. 1.

FIG. 7 is a flow chart illustrating an example of an operation which is performed in a part combination translation module in FIG. 1.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

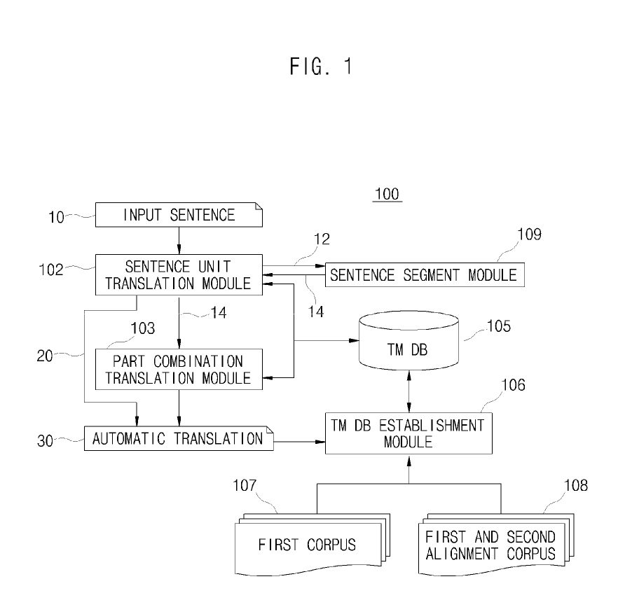

FIG. 1 is a block diagram illustrating an automatic translation system based on structured translation memory according to an exemplary embodiment.

Referring to FIG. 1, an automatic translation system 100 based on structured translation memory according to an exemplary embodiment includes a sentence unit translation module 102, a sentence segment module 109, a part combination translation module 103, and a structured translation memory establishment module 106.

The sentence unit translation module 102 receives the sentence of a first language as an input sentence 10. The sentence unit translation module 102 searches whether each sentence configuring the input sentence 10 exists in a structured Translation Memory DataBase (TM DB) 105. That is, the sentence unit translation module 102 searches whether a sentence pattern identical to or similar to each sentence pattern exists in the structured TM DB 105. When the sentence pattern identical to or similar to the each sentence pattern exists in the TM DB 105, the sentence unit translation module 102 changes the each sentence into the translation 20 of a second language and outputs the translation 20 as an automatic translation 30, on the basis of the TM DB 105. When the sentence pattern identical to or similar to the each sentence pattern does not exist in the TM DB 105, the sentence unit translation module 102 transfers the input sentence 12 to the sentence segment module 109.

The sentence segment module 109 receives the input sentence 12 that is not processed by the sentence unit translation module 102, and when the received input sentence 12 is a long sentence, the sentence segment module 109 segments the input sentence 12. When an input sentence is a long sentence, the accuracy rate of sentence analysis is largely degraded. Accordingly, because the segmented long sentence largely decreases the complexity of sentence analysis, the accuracy rate of sentence analysis can largely improve. A segmented sentence 14 is transferred to the sentence unit translation module 102 through the sentence segment module 109.

The part combination translation module 103 receives the segmented sentence 14 through the sentence unit translation module 102, and it automatically translates the segmented sentence pattern 14 on the basis of the structured TM DB 105. That is, the part combination translation module 103 combines a part translation pattern that exists in the structured TM DB 105 to automatically execute translation, and outputs the translation result as the automatic translation 30.

The TM DB establishment module 106 semi-automatically establishes the TM DB 105 by using the automatic translation 30, a first corpus 107 and a first and second alignment corpus 108.

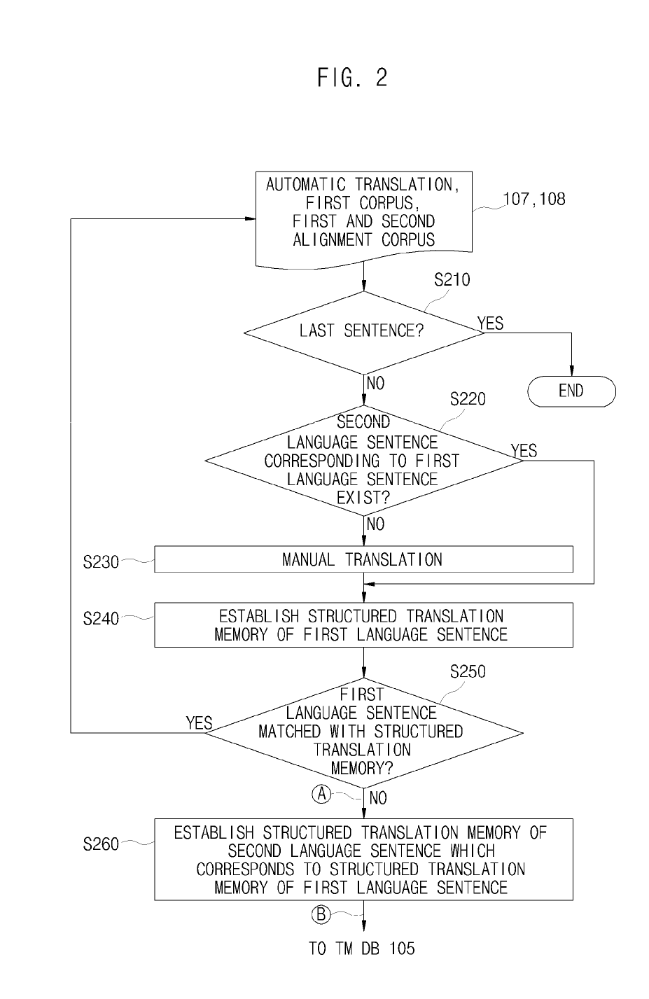

FIG. 2 is a flow chart illustrating an operation of establishing the TM DB in FIG. 1.

Referring to FIG. 2, the automatic translation system 100 determines whether a first language sentence is the last sentence, on the basis of the automatic translation 30, the first corpus 107 and the first and second alignment corpus 108 in operation S210.

When a current first language sentence is the last sentence, a processing operation is terminated.

When the first language sentence is not the last sentence, the automatic translation system 100 determines whether a second language sentence corresponding to the first language sentence exists in operation S230. When the second language sentence does not exit, manual translation in which a sentence is manually translated into the second language sentence corresponding to the first language sentence is executed in operation S230. Therefore, the first and second language sentences are established in parallel. When the second language sentence exists, an operation of establishing the structured TM of the first language sentence is performed in operation S240.

In the first and second language sentences that are established in parallel, the first and second language sentences are temporarily made in a structured translation memory type through operation S240 of establishing the structured TM of the first language sentence.

The automatic translation system 100 determines whether the first language sentence that is established in the structured TM is matched with the structured TM DB 105 that has been established before in operation S250.

When the first language sentence is matched with the structured TM DB 105, the automatic translation system 100 again performs operations S210 to S240 for a new sentence. When the first language sentence is not matched with the structured TM DB 105, the automatic translation system 100 establishes the structured translation memory of the second language sentence that corresponds to the structured TM of the first language sentence in operation S260. Consequently, the structured TM DB 105 is established through an operation that establishes the structured TM of the second language sentence corresponding to the structured TM of the first language sentence.

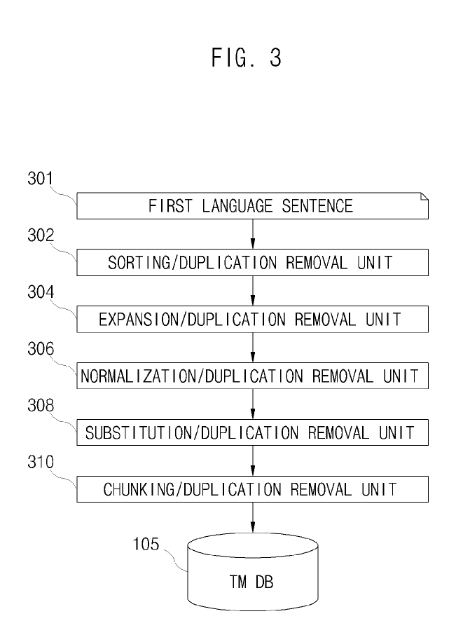

FIG. 3 is a block diagram in which operations of establishing the structured TM of the first language sentence in FIG. 2 are implemented in module types.

Referring to FIG. 3, the establishment module of the structured TM of the first language sentence includes a sorting/duplication removal unit 302, an expansion/duplication removal unit 304, a normalization/duplication removal unit 306, a substitution/duplication removal unit 308, and a chunking/duplication removal unit 310.

The sorting/duplication removal unit 302 receives a first language sentence 301 that includes the automatic translation 30, the first corpus 107 and the first and second alignment corpus 108. The sorting/duplication removal unit 302 sorts words, which configures the first language sentence 310, by length. The sorting/duplication removal unit 302 deletes a duplicated sentence pattern, a simple word and a sentence (which is configured with a compound noun) that are included in the first language sentence 310.

The expansion/duplication removal unit 304 deletes a sentence adverb pattern and a tag question pattern that exist in the first language sentence. Accordingly, the first language sentence is expanded. Moreover, when the length of the first language sentence is greater than a critical value, the expansion/duplication removal unit 304 segments the first language sentence being a long sentence into simple sentences and paraphrases the first language sentence.

The normalization/duplication removal unit 306 normalizes capital letters, which exist in the first language sentence, into lowercase letters and deletes punctuation marks that exist in the first language sentence. Moreover, the normalization/duplication removal unit 306 restores the first language sentence that has been reduced through the deletion of the punctuation marks.

The substitution/duplication removal unit 308 substitutes specific symbols for a proper noun pattern and a figure pattern that exist in the first language sentence. In this embodiment, an example in which a first symbol (NNP) and a second symbol (NUM) are respectively substituted for the proper noun pattern and the figure pattern is described. Moreover, the substitution/duplication removal unit 308 substitutes other specific symbols for personal pronouns such “he” or “she”. In this embodiment, an example that substitutes a third symbol (PRP) for a personal pronoun is described.

The chunking/duplication removal unit 310 chunks a base noun phrase pattern and an idiom pattern that exist in the first language sentence, and substitutes other specific symbols for the chunked base noun phrase pattern and idiom pattern. Herein, chunking denotes bundling pertinent information, and base noun chunking denotes bundling a base noun and information related to it. In this embodiment, an example that respectively substitutes a fourth symbol (NP) and a fifth symbol (VP) for a noun phrase pattern and an idiom pattern is described.

The first language sentence 301 is structured into a first part translation pattern in the TM DB 105 of FIG. 1 through operations that are performed in the above-described units 302, 304, 306, 308 and 310.

Hereinafter, the example sentences of the first language sentence, which are reflected in the TM that is structured through operations that are performed in the units 302, 304, 306, 308 and 310 in FIG. 3, will be described.

(1) [Input sentence] Good Morning
[A first language sentence which is registered in a structured TM] good morning

In the example sentence (1), capital letters appear in the input sentence, and a first language sentence to which an operation of changing capital letters included in the input sentence into lowercase letters is applied is registered in the structured TM.

(2) [Input sentence] Yes
[A first language sentence which is registered in a structured TM] deletion

In the example sentence (2), a sentence that is configured with a simple word appears in the input sentence, and in this case, an operation that deletes the sentence configured with the simple word is registered in the structured TM.

(3) [Input sentence] Room 777 has a beautiful view of the city
[A first language sentence which is registered in a structured TM] room NUM1 has a beautiful view of the city room NUM1 has NP1

In the example sentence (3), a capital letter, figures and a base noun phrase appear in the input sentence. In this case, a first language sentence to which an operation of changing a capital letter “R” into a lowercase letter “r”, an operation of substituting a symbol NUM1 for figures “777” and an operation of substituting a symbol NP1 for a base noun phrase “a beautiful view of the city” are sequentially applied is registered in the structured TM.

(4) [Input sentence] Please state your name, address and occupation.
[A first language sentence which is registered in a structured TM] state NP1, NP2 and NP3

In the example sentence (4), punctuation marks “,” and “.”, a capital letter “P”, a sentence adverb “Please” and three base noun phrases “your name”, “address” and “occupation” appear in the input sentence. In this case, the input sentence is changed into “please state your name address and occupation” through an operation that removes the punctuation marks and changes the capital letter into a lowercase letter. Subsequently, the input sentence is changed into “state your name address and occupation” through an operation that removes the sentence adverb “please”, and the input sentence is changed into “state NP1, NP2 and NP3” through an operation that substitutes symbols NP1, NP2 and NP3 for the base noun phrases. The finally-changed sentence “state NP1, NP2 and NP3” is registered in the structured TM.

(5) [Input sentence] I'm sorry, but I can't share that with you.
[A first language sentence which is registered in a structured TM] i can not VP1.

In the example sentence (5), two abbreviated vocabularies “I'm” and “I can't”, punctuation marks “,” and “.”, a sentence adverb “I'm sorry, but”, base noun phrases “that” and “you” and an idiom “share that with you” appear in the input sentence. In this case, the input sentence is changed into “i am sorry but I can not share that with you” through an operation that changes a capital letter into a lowercase letter, removes the punctuation marks and restores the abbreviated vocabularies. Subsequently, the input sentence is changed into “i can not share that with you” through an operation that removes the sentence adverb, and the input sentence is changed into “i can not share NP1 with NP2” through an operation of substituting the symbols of the base noun phrases. Finally, the input sentence is changed into “i can not VP1 (VP1=share NP1 with NP2)” through an operation of substituting the symbol of the idiom, and the finally-changed sentence is registered in the structured TM.

(6) [Input sentence] It's nice party, isn't it?
[A first language sentence which is registered in a structured TM] it is NP1

In the example sentence (6), a tag question “isn't it?”, a capital letter “I”, a punctuation mark “,” and a base noun phrase “nice party” appear in the input sentence. In this case, the input sentence is changed into “it is nice party” through an operation that removes the tag question, changes the capital letter into a lowercase letter and removes the punctuation mark. Finally, the input sentence is changed into “it is NP1” through an operation of substituting the symbol of the base noun phrase, and the finally-changed sentence is registered in the structured TM.

(7) [Input sentence] He stole away from the scene
[A first language sentence which is registered in a structured TM] PRP1 VP1 (VP1=stole away from NP1)

In the example sentence (7), a capital letter, a personal pronoun “He”, a base noun phrase “the scene” and an idiom “stole away from” appear in the input sentence. In this case, the input sentence is changed into “PRP stole away from the scene” through an operation that changes the capital letter into a lowercase letter and substitutes the symbol of the personal pronoun. Finally, the input sentence is changed into “PRP1 VP1 (VP1=stole away from NP1)” through an operation that respectively substitutes the symbol of the base noun phrase and the symbol of the idiom, and the finally-changed sentence is registered in the structured TM.

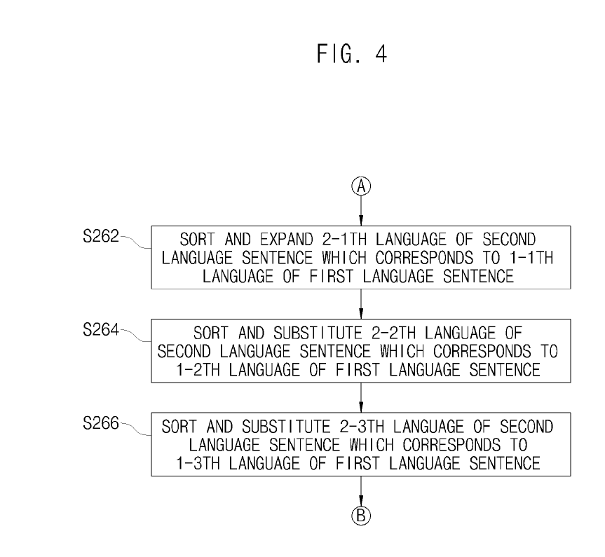

FIG. 4 is a flow chart illustrating in detail an operation that establishes the structured TM of the second language sentence corresponding to the structured TM of the first language sentence in FIG. 2.

Referring to FIG. 4, an operation of establishing the structured TM of the second language sentence may largely include three operations.

Specifically, the operation of establishing the structured TM of the second language sentence may include operation S262 that aligns and expands the 2-1th language pattern of the second language sentence corresponding to the 1-1th language pattern of the first language sentence, operation S264 that aligns and substitutes the 2-2th language pattern of the second language sentence corresponding to the 1-2th language pattern of the first language sentence, and operation S266 that aligns and substitutes the 2-3th language pattern of the second language sentence corresponding to the 1-3th language pattern of the first language sentence. Herein, the 2-1th language pattern includes an sentence adverb and a tag question. The 2-2th language pattern includes a proper noun, a figure and a pronoun. The 2-3th language pattern includes a base noun phrase and an idiom.

The operation of aligning and expanding the 2-1th language pattern includes an operation that aligns the sentence adverb and the tag question, and an operation that expands the second language sentence through an operation of removing the aligned sentence adverb and the aligned tag question. Moreover, when the 2-1th language pattern is a long sentence, the operation of aligning and expanding the 2-1th language pattern may further include an operation of segmenting the 2-1th language pattern.

The operation of aligning and substituting the 2-2th language pattern includes an operation that aligns the proper noun, the figure and the pronoun, and an operation that substitutes specific symbols for the proper noun, the figure and the pronoun. For example, the operation of substituting the specific symbols includes an operation that substitutes a symbol NNP for the proper noun, an operation that substitutes a symbol NUM for the figure, and an operation that substitutes a symbol PRP for the pronoun.

The operation of aligning and substituting the 2-3th language pattern includes an operation that aligns the base noun phrase and the idiom, and an operation that respectively substitutes other specific symbols for the aligned base noun phrase and the aligned idiom. The operation, substituting the other specific symbols for the aligned base noun phrase and the aligned idiom, includes an operation that substitutes a symbol NP for the aligned base noun phrase, and an operation that substitutes a symbol VP for the aligned idiom.

Hereinafter, the various establishment results of the second language sentence, which is registered in a structured TM corresponding to the first language sentence, will be described. In this embodiment, a result in which the second language sentence is established in the Korean language is described, but it is not limited to the Korean language and may be established in various languages.

(1) [Input sentence] Good Morning
[A first language sentence which is registered in a structured TM] good morning
[A second language sentence which is registered in a structured TM]

[symbol]

(2) [Input sentence] Yes
[A first language sentence which is registered in a structured TM]
[A second language sentence which is registered in a structured TM]

(3) [Input sentence] Room 777 has a beautiful view of the city
[A first language sentence which is registered in a structured TM] room NUM1 has NP1
[A second language sentence which is registered in a structured TM] NUM1 [symbol] NP1

[symbol]

[symbol]

(4) [Input sentence] Please state your name, address and occupation.
[A first language sentence which is registered in a structured TM] state NP1, NP2 and NP3
[A second language sentence which is registered in a structured TM] NP1, NP2 and NP3

[symbol]

(5) [Input sentence] I'm sorry, but I can't share that with you.
[A first language sentence which is registered in a structured TM] i can not VP1.
[A second language sentence which is registered in a structured TM] VP1

[symbol]

(6) [Input sentence] It's nice party, isn't it?
[A first language sentence which is registered in a structured TM] it is NP1
[A second language sentence which is registered in a structured TM] NP1

[symbol]

(7) [Input sentence] He stole away from the scene
[A first language sentence which is registered in a structured TM] PRP1 VP1 (VP1=stole away from NP1)
[A second language sentence which is registered in a structured TM] PRP1 [symbol] VP1

[symbol]

To provide a description on an operation that establishes the input sentence “Room 777 has a beautiful view of the city” as the second language sentence registered in the structured TM among the above-described establishment results, the description is as follows. The following establishment operations will be applied to the establishment operations of the other establishment results among the above-described establishment results.

[Input sentence] Room 777 has a beautiful view of the city.
777 [symbol] [symbol] [symbol]
[Change a capital letter into a lowercase letter] room 777 has a beautiful view of the city.
777 [symbol] [symbol] [symbol]
[Align figures among a 2-2th language corresponding to a 1-1th language, and substitute a symbol NUM for the figures] room NUM1 has a beautiful view of the city.
NUM1 [symbol] [symbol] [symbol]
[Align a base noun phrase among a 2-3th language corresponding to a 1-3th language, and substitute a symbol NP1 for the aligned base noun phrase] room NUM1 has NP1.
NUM1 [symbol] NP1

[symbol]

[symbol]

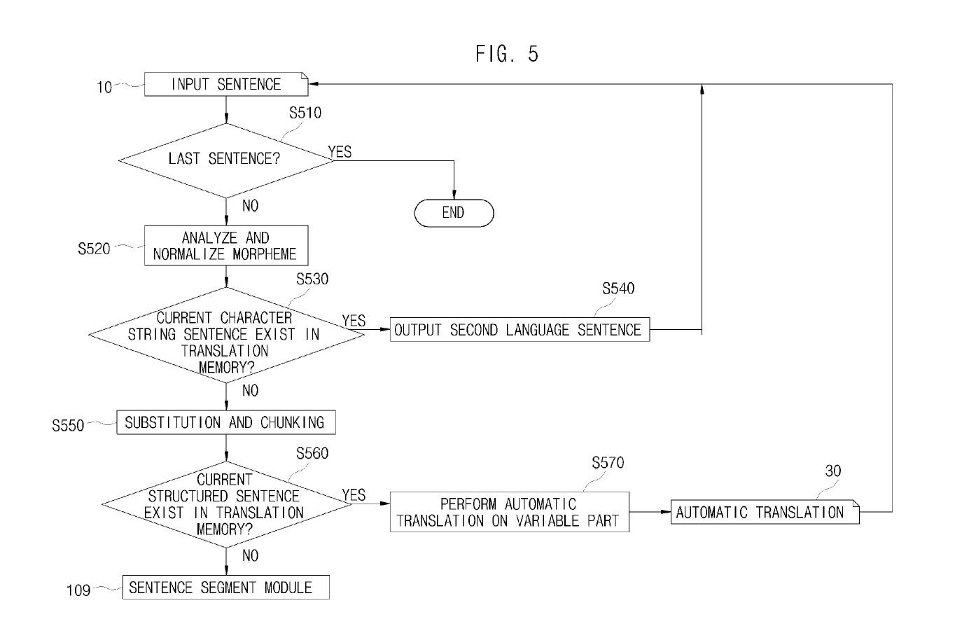

FIG. 5 is a flow chart illustrating an example of an operation which is performed in the sentence unit translation module in FIG. 1.

Referring to FIGS. 1 and 5, when the input sentence 10 is inputted, the sentence unit translation module 102 in FIG. 1 determines whether a sentence included in the input sentence 10 is the last sentence in operation S510. When the last sentence, all operations that are performed in the sentence unit translation module 102 are ended. When not the last sentence, the following operations will be performed.

The sentence unit translation module 102 performs an operation that analyzes morphemes configuring the input sentence 10 and a normalization operation in operation S520. The sentence unit translation module 102 analyzes words configuring a first language sentence in morpheme units, changes the analyzed words into the original forms and simultaneously determines the parts of speech of the analyzed words, through the operation of analyzing the morphemes of a first language included in the input sentence 10 and the normalization operation. Subsequently, the sentence unit translation module 102 performs the normalization operation that changes a capital letter included in the first language sentence into a lowercase letter, removes a punctuation mark and restores abbreviated parts.

Subsequently, by searching the structured TM DB 105, the sentence unit translation module 102 determines whether a character string sentence, which is the same as or similar to a character string sentence that is generated through operation S503 of performing the morpheme analysis operation and the normalization operation, exists.

When the character string sentence that is generated through the morpheme analysis operation and the normalization operation exists in the structured TM DB 105, the sentence unit translation module 102 outputs a second language sentence corresponding to the first language sentence in operation S540.

When the second language sentence is outputted, the sentence unit translation module 102 receives the following first language sentence as an input sentence and again performs operations S510 to S530.

When the character string sentence that is generated through the morpheme analysis operation and the normalization operation does not exist in the structured TM DB 105, the sentence unit translation module 102 performs a substitution operation and a chunking operation in operation S550. In operation S550 of performing the substitution operation and the chunking operation, a pattern recognizer that recognizes the proper noun, figures and pronoun including a personal pronoun of the first language sentence substitutes a symbol NNP for the proper noun, substitutes a symbol NUM for the figures and substitutes a symbol PRP for the pronoun. Simultaneously, a chunker performs a chunking operation on a base noun phrase pattern and an idiom pattern.

Subsequently, the sentence unit translation module 102 determines whether the performing result of operation S550 that performs the substitution operation and the chunking operation exists in the structured TM DB 105 in operation S560. When the performing result exists in the structured TM DB 105, the sentence unit translation module 102 automatically translates variable parts such as symbols NNP, NUM, PRP, NP and VP in operation S560. The sentence unit translation module 102 outputs the final automatic translation 30 that corresponds to the performing result.

When the performing result of the substitution operation and the chunking operation does not exist in the structured TM DB 105, the sentence unit translation module 102 transfers the performing result of the substitution operation and the chunking operation to the sentence segment module 109.

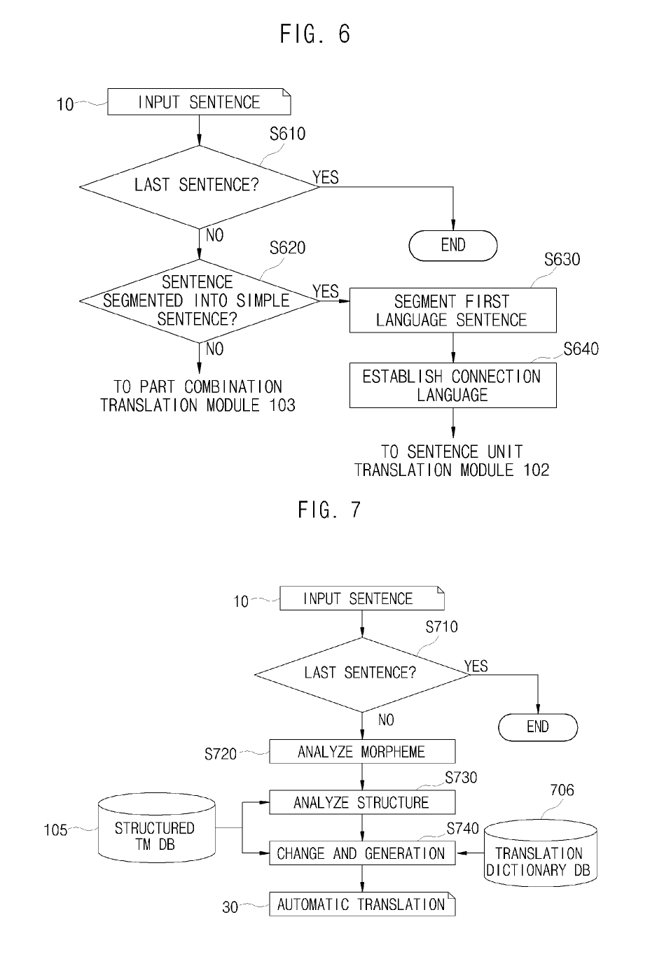

FIG. 6 is a flow chart illustrating an example of an operation which is performed in the sentence segment module in FIG. 1.

Referring to FIGS. 1 and 6, the input sentence 101 that does not exit in the structured TM DB 105 is transferred to the sentence segment module 109 by the sentence unit translation module 102.

The sentence segment module 109 determines whether the input sentence 10 is the last sentence in operation S610. When the input sentence 10 is the last sentence, all operations that are performed in the sentence segment module 109 are ended. When the input sentence 10 is not the last sentence, the following operation S620 is performed.

A user determines whether to enable to segment a first language sentence configuring the input sentence 101 into simple sentences in operation S620. That is, the sentence segment module 109 displays a query language, which queries whether to enable to read a language pattern that is included in the first language sentence, to the user through a user interface such as a display screen.

When the user transfers a response message, indicating that the language pattern may be read, to the sentence segment module 109 through the user interface, the sentence segment module 109 segments the first language sentence into simple sentences according to the response message in operation S630.

Subsequently, the sentence segment module 109 establishes a connection word for connecting a language pattern that is segmented into simple sentences, and again transfers the established connection word and the segmented language pattern to the sentence unit translation module 102 in operation S640. By searching the structured TM DB 105, the sentence unit translation module 105 performs an automatic translation operation that combines the connection word and the segmented language pattern.

When the user may not read the language pattern that is included in the first language sentence, i.e., when the user may not segment the first language sentence, the input sentence 10 is transferred to the part combination translation module 103.

FIG. 7 is a flow chart illustrating an example of an operation which is performed in the part combination translation module in FIG. 1.

Referring to FIGS. 1 and 7, the part combination translation module 103 receives the input sentence 10 that is not processed in the sentence unit translation module 102.

The part combination translation module 103 determines whether the input sentence 10 is the last sentence in operation S610.

When the input sentence 10 is the last sentence, all operations that are performed in the part combination translation module 103 are ended.

When the input sentence 10 is not the last sentence, the part combination translation module 103 performs an operation of analyzing morphemes that configures the input sentence 10.

Subsequently, the part combination translation module 103 analyzes the structures of a language pattern less than a sentence unit on the basis of the structured TM DB 105 in operation.

The part combination translation module 103 changes the analyzed language pattern less than the sentence unit into a second language sentence to generate it in connection with a translation dictionary DB 706 that is separately prepared. The generated second language sentence is provided to the user as the automatic translation 30.

As described above, the automatic translation system 100 based on structured translation memory according to an exemplary embodiment semi-automatically establishes the structured TM, and simultaneously, automatically translates an input sentence by using the structured TM.

In an operation of semi-automatically establishing the structured TM, the structured TM DB is semi-automatically established by restoring abbreviated vocabularies based on a large amount of English-Korean parallel corpus, removing a punctuation mark, removing a sentence adverb, chunking a proper noun, chunking a figure, chunking a base noun phrase and chunking an idiom.

In an operation that automatically translates an input sentence by using the structured TM, the automatic translation system 100 according to an exemplary embodiment searches whether an input sentence that is configured with an English sentence is matched with a translation memory, and when the input sentence is matched with the translation memory, a Korean sentence is outputted.

When the input sentence is not matched with the translation memory, the automatic translation system 100 proceeds to an upper stage. In the upper stage, a proper noun, a figure, a pronoun and a base noun phrase are compared with a translation memory for which a symbol is substituted. When the proper noun, the figure, the pronoun and the base noun phrase are matched with the translation memory, a Korean sentence is outputted through the change and generation of the symbol. When the proper noun, the figure, the pronoun and the base noun phrase are not matched with the translation memory, the structure of a sentence is analyzed. An idiom is recognized through a parsing operation that analyzes the structure of the sentence, and automatic translation is performed by the translation memory of a phrase unit.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An automatic translation system, comprising:
a translation memory establishment module changing a predetermined language pattern into a part translation pattern by changing, deleting and substituting the predetermined language pattern less than a sentence unit, and registering the changed part translation pattern in a structured translation memory;
a sentence unit translation module performing a translation of the sentence unit on an input sentence on the basis of the translation memory; and
a part combination translation module analyzing a structure of a language pattern less than the sentence unit which is comprised in the input sentence, searching the registered part translation pattern which is matched with the analyzed language pattern on the basis of the translation memory, and combining the searched part translation pattern to output a translation corresponding to the input sentence, when the translation of the sentence unit is failed.

2. The automatic translation system of claim 1, further comprising a sentence segment module receiving the input sentence from the sentence unit translation module, segmenting the received input sentence into a language pattern less than the sentence unit, and transferring the segmented language pattern to the part combination translation module through the sentence unit translation module, when the translation of the sentence unit is failed on the input sentence.

3. The automatic translation system of claim 2, wherein the sentence segment module segments the input sentence into the predetermined language pattern less than the sentence unit, when the input sentence is a long sentence.

4. The automatic translation system of claim 3, wherein the sentence segment module transferring a query message, which queries whether to enable read the input sentence of the long sentence, to a user through a user interface, receiving a response message which indicates that the user can read the input sentence of the long sentence through the user interface, and segmenting the input sentence of the long sentence.

5. The automatic translation system of claim 1, wherein the translation memory establishment module changes the predetermined language pattern, which comprises a simple word pattern, a compound noun pattern, a proper noun pattern, a figure pattern, a pronoun pattern, a noun phrase pattern and an idiom pattern, into the part translation pattern.

6. The automatic translation system of claim 5, wherein the translation memory establishment module substitutes a specific symbol for the language pattern of the input sentence which is matched with the predetermined language pattern to establish a first language sentence corresponding to the input sentence, substitutes the specific symbol for the language pattern of the translation which is matched with the predetermined language pattern to establish a second language sentence corresponding to the translation, and establishes a translation memory database on the basis of the established first and second language sentences.

7. The automatic translation system of claim 6, wherein the translation memory establishment module comprises:
a sorting/duplication removal unit sorting words, which are comprised in the first language sentence, by length, and deleting the simple word pattern and the compound noun pattern which are comprised in the first language sentence;
an expansion/duplication removal unit expanding the first language sentence by deleting a sentence adverb pattern and a tag question pattern which are comprised in the first language sentence;
a normalization/duplication removal unit deleting a punctuation mark pattern which is comprised in the first language sentence, and restoring a sentence pattern of the first language sentence which is abbreviated by deleting the sentence adverb pattern, the tag question pattern and the punctuation mark pattern;
a substitution/duplication removal unit substituting a first symbol, a second symbol and a third symbol for the proper noun pattern, the figure pattern and the pronoun pattern, respectively; and
a chunking/duplication removal unit chunking the noun phrase pattern and the idiom pattern, and substituting a fourth symbol and a fifth symbol for the chunked noun phrase pattern and idiom pattern.

8. The automatic translation system of claim 7, wherein the expansion/duplication removal unit segments the first language sentence into a plurality of simple sentences, when a length of the first language sentence is greater than a critical value.

9. The automatic translation system of claim 7, wherein the normalization/duplication removal unit changes a capital letter, which is comprised in the first language sentence, into a lowercase letter.

10. An automatic translation method, comprising:
changing a predetermined language pattern into a part translation pattern to establish a structured translation memory by changing, deleting and substituting the predetermined language pattern less than a sentence unit;
performing a translation of the sentence unit on an input sentence on the basis of the translation memory; and
analyzing a structure of a language pattern less than the sentence unit which is comprised in the input sentence, searching the translation memory, and combining the part translation pattern corresponding to the analyzed language pattern to output a translation, when the translation of the sentence unit is failed.

11. The automatic translation method of claim 10, further comprising segmenting the input sentence into the predetermined language pattern less than the sentence unit, when the input sentence is a long sentence.

12. The automatic translation method of claim 10, wherein the establishing of a structured translation memory structures the predetermined language pattern, which comprises a simple word pattern, a compound noun pattern, a proper noun pattern, a figure pattern, a pronoun pattern, a noun phrase pattern and an idiom pattern, into the part translation pattern.

13. The automatic translation method of claim 12, wherein the establishing of a structured translation memory comprises:
substituting a specific symbol for the language pattern of the input sentence which is matched with the predetermined language pattern to establish a first language sentence corresponding to the input sentence;
substituting the specific symbol for the language pattern of the translation which is matched with the predetermined language pattern to establish a second language sentence corresponding to the translation; and
establishing a translation memory database on the basis of the established first and second language sentences.

14. The automatic translation method of claim 13, wherein the establishing of a first language sentence comprises:
sorting words, which are comprised in the first language sentence, by length, and deleting the simple word pattern and the compound noun pattern which are comprised in the first language sentence;
expanding the first language sentence by deleting a sentence adverb pattern and a tag question pattern which are comprised in the first language sentence;
deleting a punctuation mark pattern which is comprised in the first language sentence, and restoring a sentence pattern of the first language sentence which is abbreviated by deleting the sentence adverb pattern, the tag question pattern and the punctuation mark pattern;
substituting a first symbol, a second symbol and a third symbol for the proper noun pattern, the figure pattern and the pronoun pattern, respectively; and
chunking the noun phrase pattern and the idiom pattern, and substituting a fourth symbol and a fifth symbol for the chunked noun phrase pattern and idiom pattern.

15. The automatic translation method of claim 14, wherein the establishing of a second language sentence comprises:
sorting and deleting a sentence adverb pattern and tag question pattern of the second language sentence which correspond to the sentence adverb pattern and tag question pattern of the first language sentence;
sorting a proper noun pattern, figure pattern and pronoun pattern of the second language sentence which correspond to the proper noun pattern, figure pattern and pronoun pattern of the first language sentence, and respectively substituting the first to third symbols for the sorted proper noun pattern, figure pattern and pronoun pattern of the second language sentence; and
sorting a noun phrase pattern and idiom pattern of the second language sentence which correspond to the noun phrase pattern and idiom pattern of the first language sentence, and respectively substituting the fourth and fifth symbols for the sorted noun phrase pattern and idiom pattern of the second language sentence.

16. The automatic translation method of claim 15, further comprising segmenting the second language sentence into a plurality of simple sentences, when the second language sentence is a long sentence in which a length of the second language sentence is greater than a critical value.

17. The automatic translation method of claim 10, wherein the combining of the part translation pattern comprises:
analyzing a morpheme which configures the input sentence;
analyzing the language pattern less than the sentence unit which configures the input sentence by using the analyzed morpheme and the translation memory database; and
outputting the analyzed language pattern as a final translation by using a translation dictionary database.
